(19) United States
(12) Patent Application Publication
(10) Pub. No.: US 2025/0153129 A1
(43) Pub. Date: May 15, 2025

(54) PLANT, DEVICE AND PROCESS

(71) Applicant: GIDARA ENERGY B.V., Schiphol (NL)

(72) Inventors: Elyas Moghaddam, Schiphol (NL); Dobrin Toporov, Schiphol (NL); Nivya Uday Kodimaniyanda, Schiphol (NL); Alireza Mohammadi, Schiphol (NL); Wim Van der Zande, Schiphol (NL); Chris Van der Zande, Schiphol (NL); Ralf Abraham, Schiphol (NP); Alfred Hoffmann, Schiphol (NL); Domenico Pavone, Schiphol (NL)

(21) Appl. No.: 18/840,518

(22) PCT Filed: Feb. 24, 2023
(86) PCT No.: PCT/EP2023/054659

§ 371 Date: Aug. 22, 2024

(30) Foreign Application Priority Data
Feb. 25, 2022 (DE) 20 2022 000 489.3

(51) Int. Cl. B01J 8/18; B01D 45/16; B01J 8/00; C01B 3/02; C10J 3/56

(52) U.S. Cl. CPC B01J 8/1818; B01D 45/16; B01J 8/006; C01B 3/02; C10J 3/56

(57) ABSTRACT

The present invention relates to plant for the conversion of carbon-containing feedstock to a versatile synthesis gas product. The conversion is facilitated by the gasification of carbon-containing biomass and waste materials into synthesis gas. A high carbon-conversion of the biomass and/or waste material is achieved through the incorporation of a post-treatment separation device downstream of the gasifier to further convert the dust and other gaseous by-products in the syngas that still have a significantly high carbon content.

### TECHNICAL FIELD

The present invention relates to a plant, device and a process for optimizing the production of synthesis gas from biogenic carbon-containing residues and waste materials into synthesis gas.

### BACKGROUND

In the recent past, climate protection has become the most important issue worldwide and the central challenge of international politics. In addition to the expansion of wind and solar technologies, the increased use of biomass and residues to substitute fossil energies/carbon is seen as a target-oriented measure regarding the current climate-related challenges.

Residual and waste materials are increasingly used for the production of green energy because they have already completed a life cycle or, as biogenic mass, have only just absorbed the carbon from the atmosphere in the life cycle. In addition, these occur in large quantities in agriculture and forestry, in industry and last but not least by the end consumer. Disposal by incineration—as is currently the case with around 50% of plastic waste-does not make a sufficient contribution to reducing greenhouse gases. This is due to the fact that chemical use has a significantly higher degree of efficiency, does not emit carbon again, but mostly binds it, and only then further material use becomes possible again. You can therefore make an important contribution to sustainable energy supply through the recycling of carbon (carbon cycle).

Thermochemical processes such as pyrolysis and gasification are considered promising for the energetic use of residues and waste materials in order to be able to use previously little or unused biomass resources or non-recyclable waste. The focus of international activities is on generating solid (e.g. charcoal), liquid or gaseous energy carriers from the starting material with maximum efficiency in order to replace the fossil energy sources used up to now or to make them significantly more efficient.

There is already a whole range of methods and devices for converting these substances efficiently and with low emissions using pyrolysis and/or gasification methods. However, some of these techniques are more than 50 years old and require extensive adaptation and optimization. It should also be noted that the quality of raw materials and availability can vary greatly, so stable and reliable technologies are essential.

The temperature range in conventional fluidized bed gasifiers depends on the characteristics of biogenic-content residuals and waste materials such as reactivity, ash melting behaviour at reduced condition, etc., and pressure of the system, resulting in an even wider thermal range of 600-1200° C. in a broader sense in all types of stationary and moving fluidized bed gasifiers. The advantages of gasification in a fluidized bed are the relatively simple preparation of the starting material, the very good material and heat transport, as well as the problem-free conversion of problematic waste, which for example contains halogenated hydrocarbons, sulphur, heavy metals and many more. No toxins such as dioxins, furans, etc. are formed in the reducing atmosphere of gasification. A problem with the known technology for gasifying residues and waste materials in a fluidized bed is that the C, i.e. carbon, conversion is not yet sufficient or could be significantly improved. This is due to the relatively moderate operating temperatures, i.e. lower ash melting point, which is relevant to conventional fluidized bed gasification processes.

In the gasification of ash-containing fuels under stationary fluidized bed conditions, in particular, high C contents of over 40% are still found in the dust separation. This means that the TOC content (Total Organic Carbon=oxidizable carbon) is too high for simple landfilling according to landfill classes 1 & 2 of the TA municipal waste (TA municipal waste landfill class 2<5% TOC).

In addition, the use of energy is incomplete, and the synthesis gas yield is insufficient. In order to utilize the remaining carbon and to make it suitable for landfill, the carbon-containing dust from the dust separation (e.g. hot gas filter) has to be post-treated up to now. As a rule, such an after-treatment is carried out by combustion in a separate boiler, with the associated design and economic effort and increased CO₂ emissions. A further complication is that in the recent past, biomass with a high alkali content (sodium & potassium) has been increasingly used. These alkalis evaporate during gasification and can condense in the temperature window of the required gas cleaning and clog the equipment for solids separation, so that cleaning in a cyclone or filter, for example, is no longer possible, and the result is a constant increase in pressure loss until the plant must be shut down.

Scientifically, this is typical for all fluidized bed gasification processes wherein even the inclusion of cyclone cannot assist preventing dust carryover at downstream of the reactor, and thus the entrained dust must be removed at downstream of all known and state-of-the-art fluidized bed gasification process. This is the subject of typical fluidized bed gasification processes comprising the referred U.S. Pat. No. 8,137,655 B2.

Canadian patent CA 3135515 C discloses a method with a carbon conversion rate of 78% for converting carbonaceous material into syngas. According to the method disclosed, the carbonaceous material is gasified in a fluidized bed reactor to produce crude syngas which is classified by particle aerodynamic velocity in a cut sizing device and thereby reformed to synthesis gas in a thermal reformer or entrained flow gasifier operating at temperatures above the ash melting point of the feedstock. This application used a thermal reformer comprising a cooling wall membrane made of studded cooling pipes. On reforming of the crude syngas in this thermal reformer, the molten solids formed from the char, bed material and mineral matter, etc. present in the crude syngas form a protective layer on the cooling wall. However, the carbon conversion rate is not ideal.

It is worth noting that modifying the abovementioned gasification system by adding the state-of-the-art entrained-flow-type gasifier at downstream of a typical fluidized bed gasifier which is the subject of Canadian patent CA 3135515 C and U.S. Pat. No. 6,902,711 B1 cannot unsettle the entrainment of high C content dust in the produced raw syngas, thereby still necessitating a dust filtration unit downstream. This also implicates an improper conversion/recovery of high C content.

Another disadvantage of the gasification of carbon-containing material using fluidized bed gasifiers is that, in addition to the main products such as CO, H₂, CO₂, CH₄ and H₂O, additional by-products that are not yet fully converted at the gasification temperature of 900° C. to 1100° C. are included. These are products such as benzene (C₆H₆), naphthalene (C₁₀H₈) or ammonia (NH₃), which have resisted complete conversion and leave the gasifier with the raw gas produced in gaseous form. As part of the subsequent gas treatment, these accompanying substances have to be separated at various points in downstream facilities and disposed of in additional systems, which is very laborious. However, these accompanying substances are combustible and separation from the synthesis gas stream leads to a reduction in the energetic and material efficiency of the fluidized bed process.

So far, however, the treatment of residual carbon in hot gas filter dust, other than external combustion or dust recirculation to the gasifier, has not been carried out in a satisfactory manner, especially in pressurized HTW processes. In addition, dust recirculation also increases the concentration of pollutants that cannot be thermally converted (e.g. heavy metals) in the gasifier. To avoid/mitigate this disadvantage, the hot gas filter must be provided with an additional silo plus extraction devices and control.

Although the hydrocarbons (HCs) comprising tars in raw syngas improve the calorific value of the produced syngas, their existence can be a hurdle, if the syngas is to be used for synthesis of biofuels or bio-chemicals. Therefore, the production of cleaner syngas (mostly containing CO and H₂) is the primary aim of every process route that includes gasification with subsequent synthesis. Speaking of HCs, particularly light aromatics comprising benzene (C₆H₆) and polyaromatics comprising naphthalene (C₁₀H₈) which are typical undesired products within the raw syngas, formed due to moderate operational thermal range in typical fluidized bed gasification process would need higher temperatures, say around or slightly above ash fusion point, to further crack or thermally decompose/reform into H₂ and CO. Such a thermal zone cannot be made in typical fluidized bed gasification system, which is a known-scientific fact explained by softening of dust particulates and agglomeration in the system, ending with blockage and shutdown of the plant, which is the subject of U.S. Pat. No. 8,137,655 B2 and US 2020/0255754 A1. In case of waste gasification, an expert in the field may consider some other acid-gas impurities comprising H₂S, HCN, HCl, etc. which make catalytic conversion of the motioned tars complicated and problematic due to the poisoning by the above-mentioned acidic impurities.

Therefore, it is an object to provide an improved gasification means and processes addressing the above disadvantages.

### SUMMARY

The object is solved by the present invention and in particular its aspects and embodiments as described herein.

In a first aspect, the present invention is directed to a plant for converting carbon-containing residues and waste materials into synthesis gas, comprising a gasification reactor with at least one fluidized bed zone in which the residues and waste materials are gasified by suitable gasification means, with carbon-containing dust at the outlet of the gasification reactor in the raw gas, and a bulk layer separator is arranged downstream of the gasification reactor, in which the carbon-containing dust is oxidized by supplying an oxidizing agent, characterized in that the device for oxidizing the carbon-containing dust is operated above the flow temperature of the ash.

In a second aspect, the present invention is directed to a device for the thermal conversion of carbonaceous dust from raw gases, comprising melting the mineral content of the dust in the liquid state and separating it from the raw gas within a ceramic bed.

In a third aspect, the present invention is directed to a process of converting carbon-containing residues and/or waste materials into synthesis gas or of thermally converting carbonaceous dust from raw gases, the process comprising the steps of:
heating the carbon containing residue, waste material or carbonaceous dust above a flow temperature of an ash included in the carbon containing residue, waste material or carbonaceous dust to obtain reformed clean synthesis gas and an ash melt; and
separating the ash melt within a ceramic bed.

In particular, these aspects also enable the conversion of unwanted and detrimental gaseous by-products as described herein below in more detail.

### Technical Effects of the Present Invention

Overall, the present invention according to the aspects described above, which will also be described in more detail below, have the following non-limiting technical effects and benefits:
(i) the energy content of the carbonaceous dust and gaseous by-products are recovered for gas production,
(ii) the amount and quality of synthesis gas produced is increased, thereby increasing the cold gas efficiency of the gasification process,
(iii) the cost of separating (methane, benzene, naphthalene) from the synthesis gas is avoided or can be eliminated,
(iv) the transport and disposal of the above-mentioned solids are significantly simplified,
(v) a large part of the equipment units that are still required can be made more compact,
(vi) the present invention is significantly more advantageous with regard to the CO₂ footprint than the methods used hitherto according to the current state of the art,
(vii) the invention offers a significant reduction in capital expenses and operational expenses by eliminating hot gas filter with the very costly connected lock hoppering system and collecting silos.
(viii) the invention offers further decarbonization of bottom product in this device whilst the connected and required peripherals can be made in a much more compact fashion.
(ix) based on the method devised and offered device, all tars and hydrocarbons along with ammonia are fully thermochemically reformed to syngas with additional heat to be provided by small amounts of oxygen or thermal (steam) plasma source while no further separation units at downstream of gasification island are needed.
(x) according to this invention, using this device under the devised method, non-elutable granulate is formed and this granulate takes up only about ⅓ of the volume of the C-containing dust. This type of granulate is widely used in the construction industry, as a blasting agent or in road construction. This way, the process would not produce undesired hazardous dust, with more than 40% C content, to be collected in the hot gas filter.
(xi) the invention offers a method and device whereby the vaporous alkalis are all bound/dissolved/captured in the liquid/molten ash. This method by in-situ capturing of vaporous alkalis, unsettles the problematic condensation of alkalis in the downstream plant areas.
(xii) according to the invention, the produced syngas is clean as such, implicating a quality of tar-free, alkalis-free and dust-free syngas.

Overall, it has been surprisingly found that the present invention, e.g. according to the first, second and third aspects, is significantly more advantageous with regard to the CO₂ footprint than the solutions provided in the prior art.

### BRIEF DESCRIPTION OF THE FIGURES

FIG. 1 shows a simplified representation of the gasifier with feed units for the residual and waste material, as well as raw gas cooler and hot gas filter according to the state of the art.

FIG. 2 shows a simplified representation of a plant according to the present invention.

### DETAILED DESCRIPTION

With a device or plant according to the first or second aspect of the present invention or a process according to the third aspect of this invention, this object is achieved according to the invention in that a hot gas filter (WGF) downstream of the raw gas cooler with the very extensive periphery (cleaning, dust removal and return system to the gasifier) is dispensed with. Instead, a packed bed separator (ceramic bulk layer filter), also referred to as “bulk layer separator” herein, is positioned at the outlet of the gasifier (recirculation cyclone), which is controlled by the generation of additional heat through the addition of oxygen and is operated above the flow point of the ash flow temperature. The raw gas, which is loaded with ash and residual carbon, is exposed to oxygen in front of the ceramic bed, which reacts spontaneously under the given process conditions. The heat released in the process converts the residual carbon into synthesis gas components. The mineral dusts are converted to the liquid state under temperature control and separated and agglomerated within the ceramic bed, then flow off the ceramic bodies as a liquid mineral film due to an inertial force, such as gravity, in a water-filled granulation bath below the bed separator and form a glass-like, non-elutable granulate. The granules can be separated and discharged from the water in a simple manner and are available for a wide range of applications (carbon-free).

An additional advantage of this procedure is that experience has shown that the vaporous alkalis are bound/dissolved in the liquid ash and cannot condense in the downstream plant areas. In addition, heat is obtained through the exothermic decomposition of the by-products (benzene, naphthalene, ammonia, methane, etc.), which then contributes to improving the gas quality by shifting the above-mentioned gas equilibrium.

Superheated steam is added to the treated gas at the outlet of the bulk layer separator in order to shift the water gas balance in the direction of an increased hydrogen content in the synthesis gas.

It then flows first through a steam superheater and then to a raw gas cooler, in which process steam is generated. Now the raw gas can be cleaned and adjusted to synthesis gas in the usual way.

Advantageously, depending on the feedstock, the synthesis gas yield can be increased by approx. 5-10% with this arrangement: 4% via increased C conversion and conversion of the by-products and 3-6% via the breakdown of CH₄ via the increased temperature and corresponding equilibrium shift.

Another advantage is that no additional systems are required for the decomposition or recycling of disruptive by-products from the raw gas. For example, complete decomposition of benzene and naphthalene is only achieved at temperatures >1200° C. A correspondingly high local temperature in the post-gasification zone of a HTW gasifier would increase the risk of slagging in the gasifier enormously. This is excluded when the temperature is purposefully raised above the ash flow point within the packed bed separator.

In particular, any suitable feedstock comprising biomass and/or carbon-containing solid waste material is suitable to be processed within the aspects of the present invention. In alternative embodiments the feedstock comprises biomass. In an alternative embodiment the feedstock comprises a carbon-containing solid waste material. In some embodiments, the feedstock comprises only biomass, in other embodiments only carbon-containing solid waste material and in further embodiments comprises a blend of biomass and carbon-containing solid waste material.

“Biomass” refers to materials typically classed as biomass i.e., organic matter. Examples of biomass that may be used in the invention are wood and plants. Carbon-containing solid waste material is defined as any form of solid waste which comprises material that is carbon-containing. Examples of carbon-containing solid waste include wastes such as wood waste, agricultural waste, municipal solid waste (MSW), refuse derived fuels (RDF), dried sewage sludge and industrial waste. The above materials may be processed in the invention alone or in combination with one another in a blend. Preferred feedstocks include: RDF, MSW, waste wood (preferably untreated) and hard wood, all of which may be processed alone or in combination with one another. In particular, preferred feedstocks are selected from RDF alone, MSW alone, RDF and MSW blend, RDF with plastic, untreated wood and hard wood. Particularly preferred is the use of an RDF and MSW blend.

### Definitions

As used herein, the term “ceramic bodies” refers to slag resistant, heat resistant and mechanically stable shaped bodies comprising or consisting of a ceramic material.

As used herein, “upstream” is a relative term describing an earlier stage or a preceding position in the process or process plant, e.g. of a process unit, relative to the direction of the stream of the process components, i.e. feedstock and synthesis gas, through the process and plant, and, therefore, takes the usual meaning in the field. As a non-limiting example, within a classical gasification process, a gasifier is arranged upstream of a product raw gas cooler.

As used herein, “downstream” is a relative term describing a later stage or a subsequent position within the process or process plant, e.g. of a process unit, relative to the direction of the stream of the process components, i.e. feedstock and synthesis gas, through the process and plant, and, therefore, takes the usual meaning in the field. As a non-limiting example, within a classical gasification process, such as a High Temperature Winkler (HTW) process, a cyclone separator is arranged downstream of the gasifier.

As used herein, the term “ash flow temperature” or “flow temperature of the ash” takes its usual meaning in the art. Ash flow temperatures when referred to herein is measured experimentally using the standard methods DIN 51730:2022-02, DIN EN ISO 21404:2020-06 and/or CEN/TS 15404. For example, materials such as RDF pellets have an ash flow temperature (FT) (measured according CEN/TS 15404)=1310° C. at reducing atmosphere. Wood pellets have an. FT=1355° C. or pellets made from 50% wood and 50% RDF have an FT=1335° C.

As used herein, the term “with respect to the earth's surface” is used as a positional reference within the inventive process and process plant and the various zones in the gasifier or bulk layer separator are counted beginning from the closest distance from the earth's surface ending at the farthest distance from the earth's surface under the consideration of a set-up where the gasifier is used in an upright position with an upwards flow, i.e. away from the earth's surface, of the process components, i.e. feedstock and synthesis gas. For example, the fluidized bed zone of the gasifier is arranged at a lower position than the post-gasification zone with respect to the earth's surface. As further used herein, if a second zone is arranged “on top” of a first zone or part it means that the second zone or part directly follows the first zone, i.e. without a space in between, and the second zone being arranged at a higher position than the first zone with respect to an earth's surface. In one example, the bulk layer separator comprises a top part and a bottom part, wherein the top part is above the bottom part with respect to the earth's surface.

The terms “converting a carbon-containing solid fuel to synthesis gas” and “gasification/gasifying” are used interchangeably herein.

As used herein, the term “pressure-loaded gasifier” means that the operating pressure within the gasifier, e.g. the fluidized bed zone and the post-gasification zone, is above atmospheric pressure. Preferably, the gasifier of the present invention, i.e. the fluidized bed and post-gasification zones are operated in a pressure-loaded mode. In other words, the gasifier of the first, second and third aspect of the present invention is preferably a pressure-loaded gasifier. Such pressure used to operate the pressure-loaded gasifier, or a pressure-loaded gasifying process can comprise pressure ranges of between about 200 kPa and about 3000 kPa or between about 200 kPa and about 4000 kPa, more optionally between about 1000 kPa and about 3000 kPa or between about 200 kPa and about 4000 kPa.

As used herein “High Temperature Winker” gasification or abbreviated “HTW” gasification can be described as a pressure-loaded bubbling fluidized bed gasification process. The reactor for carrying out HTW gasification is called “HTW” gasifier. A HTW gasifier is the preferred gasifier for carrying out the inventive process and to be used in the inventive process plant. A HTW gasifier is a refractory-lined reactor, typically comprising a fluidized bed zone and a post-gasification zone, such as a freeboard zone, wherein the reactor is equipped with a cyclone separator and recirculation line. A HTW gasifier is typically operated under elevated pressures disclosed herein, such as about 200 kPa to about 3000 kPa or 200 kPa to about 4000 kPa, and temperatures disclosed herein with respect to the present invention. A HTW gasifier is well known in the art and for example described by S. De et al., Coal and Biomass Gasification-Recent Advances and Further Challenges, Springer Nature Singapore Pte Ltd, published 2018 which is incorporated herein in its entirety.

As used herein, the term “carbon conversion efficiency” (CCE) represents the percentage of total carbon in the gasifier feedstock, which is successfully converted to product gases, which contain carbon (such as CO, CO₂, CH₄, C₂H₂, C₂H₄, C₂H₆, C₆H₆ and C₁₀H₈).

As used herein, the term “Cold Gas Efficiency (CGE)” represents the ratio of chemical energy stored in the raw syngas over the chemical energy stored in the solid feedstock.

The terms “packed bed separator” is arranged within “bulk layer separator”. “Packed bed separator”, “packed bed filter” and “ceramic bulk layer filter” are used interchangeably herein. They typically denote a ceramic bed comprising or being composed of separate ceramic bodies as also described herein.

As used herein “carbonaceous dust from raw gases” typically denotes dust resulting from an upstream coal gasification process but can also encompass carbonaceous dust suitable for an entrained flow gasification. Such “carbonaceous dust” typically involves oxidizable carbon, such as hydrocarbons and/or arenes, as well as mineral matter, such as ash.

As used herein, the term “average temperature” takes it usual meaning within the art and refers to the average temperature of each step and/or unit and it will be understood that within each step and/or a certain part of a reactor where higher/lower temperatures than the average will likely be present. The “average temperature” can be determined in accordance with methods known to the skilled person. In particular, an average temperature can be determined by placing multiple thermocouples at different locations within a certain part of a reactor, e.g. of a gasifier, for measuring the individual temperatures at said locations. In this measurement setup, the average temperature is the mean temperature of the individual temperatures (usually the instant gas temperatures) measured by said thermocouples (by their thermoelements) at said different locations in a zone of the unit (such as the bulk layer separator) over a certain time period. In particular, if the average temperature remains constant the process conditions are considered stable. A reactor as described herein may also be the bulk layer separator having a top part and a bottom part as described below. In particular, whenever a “temperature” as a parameter is mentioned herein, reference may be made to the “average temperature”.

The terms “gasifier” and “gasification reactor” are used interchangeably herein.

As used herein, the term “about” referring to numerical values can cover the respective value in a range of ±10%; ±5%, ±2%; or ±1%.

Plant for Converting Carbon-Containing Residues and Waste Materials into Synthesis Gas

In a first aspect, the present invention is directed to a plant for converting carbon-containing residues and waste materials into synthesis gas, comprising a gasification reactor with at least one fluidized bed zone in which the residues and waste materials are gasified by suitable gasification means, with carbon-containing dust at the outlet of the gasification reactor in the raw gas, and a bulk layer separator is arranged downstream of the gasification reactor, in which the carbon-containing dust is oxidized by supplying an oxidizing agent, characterized in that the device for oxidizing the carbon-containing dust is operated above the flow temperature of the ash.

In other words, feedstock, e.g. carbon-containing residues and waste materials, described elsewhere herein is introduced in a gasification reactor in order to produce raw gas, containing main products CO, H₂, CO₂, CH₄ and H₂O, additional by-products that are not yet fully converted at the gasification temperature of 900° C. to 1100° C. such as hydrocarbons having a higher weight, benzene (C₆H₆), naphthalene (C₁₀H₈) or ammonia (NH₃), as well as ash particles. Unreacted products are referred to as “carbon-containing dust”. This carbon containing dust exits a cyclone separator in a fluidized bed gasification process. This carbon containing dust is oxidized in a bulk layer separator being arranged downstream of the gasification reactor. The unreacted products are converted into predominantly synthesis gas.

In addition, the ash particles are molten by heating over the flow temperature of the ash and separated by e.g. a ceramic bed in the bulk layer separator via inertial force. Therefore, the carbon conversion rate of the feedstock is significantly increased and carbon conversion is almost complete. In other words, a carbon conversion rate which may be close to 100% can be provided. As the ash can be essentially completely separated, no hot gas filter is needed. In one example, 99.9% of particulate matter is captured/separated from the syngas flow. In particular, the 0.1% may comprise particles having a diameter of much less than 1 μm constituting e.g. a particulate matter of 1 to 3 mg per Nm³. However, 100% of particles larger than 5 μm are usually separated due to the device and/or plant and/or process according to the present invention.

The plant for converting carbon-containing residues according to the first aspect of the present invention may include a device according to the second aspect of the present invention as the bulk layer separator. Accordingly, in order to avoid repetitions, it is stated that all features and technical advantages relating to the device are also applicable for the plant.

Due to a plant according to the first aspect, it is possible to convert unwanted by-products into usable product gas in this facility. When the substances mentioned, residual carbon, methane, benzene, naphthalene and ammonia, react with small amounts of oxygen, additional heat is generated, which, through the subsequent addition of water vapor, brings the reaction equilibrium (Boudouard and water gas equilibrium) into the advantageous ones for the gasification process shifted direction. This is where the invention comes in, the object of which is to improve the yield of such a procedure and to reduce plant costs.

A bulk layer separator vessel may in be constituted in the same manner as an entrained flow gasifier. It may be operated in a flow direction from top to bottom with respect to an earth's surface. A top part of the bulk layer separator may include an inlet configured to introduce the carbon-containing dust. Within the bulk layer separator downstream of the inlet, there may be top part with a supply for an oxidizing agent configured to deliver an oxidizing agent into the bulk layer separator. This supply can also be a plasma torch, as long as it is possible to provide a temperature being high enough to oxidize the unreacted carbon-containing products and to heat the carbon-containing dust above the flow temperature of the ash. Furthermore, the top part is a reaction volume which does not involve a packed bed separator. Downstream of the top part in the bottom part of the bulk layer separator a packed bed separator, also referred to as ceramic bulk layer filter is arranged downstream of the supply. The packed bed separator may involve a ceramic bed. The ash molten in the top part by heating the dust above the flow temperature of the ash is separated from the gas on the ceramic bed. In other words, the ceramic bed is configured to extract the molten ash. This might be possible by a spherical shape and by the structure disclosed elsewhere herein. Without wishing to be bound by a particular theory, it is assumed that in the ceramic bed the ash or mineral dusts are converted to the liquid state under temperature control and separated and agglomerated within the ceramic bed, then flow off the ceramic bodies as a liquid mineral film due to gravity in a water-filled granulation bath below the bed separator and form a glass-like, non-elutable granulate. The ceramic bed leads the molten ash to an ash outlet at bottom part of the bulk layer separator, the ash outlet being arranged downstream of the packed bed separator, e.g. the ceramic bed. Downstream of the outlet, i.e. downstream of the bulk layer separator, a granulating bath may be arranged in order to cool down the molten ash into granules. Furthermore, the bulk layer separator may involve a gas outlet, being configured to lead out the product gas.

The gasification reactor may be a High Temperature Winkler (HTW) reactor as defined herein.

In certain embodiments being combinable with all other embodiments herein, the bulk layer separator comprises a ceramic bed comprising ceramic bodies. This ceramic bed is comprised in or constitutes the packed bed separator. In particular, the ceramic bodies may be spherical. In other words, the ceramic bodies have the shape of a sphere. Such arrangement can be additionally helpful for the extraction of the molten ash and to lead the ash to the outlet in the bottom part of the bulk layer separator.

The chemical composition of the ceramic bodies is not critical as long as they show a certain degree of resistance with respect to the liquid slag. In certain embodiments being combinable with other embodiments herein, the ceramic bodies comprise a material selected from the group consisting of: Al₂O₃, SiO₂, SiC, Si₃N₄, B₄C, BN, Zr₂O₃, Cr₂O₃, MoSi₂, HfO₂ or a combination thereof. “A combination thereof” means that any of the materials can be combined with each other, either in a two or more component system. Preferably the ceramic bodies are composed of Cr₂O₃. In another preferred embodiment, the ceramic bodies may be composed of Al₂O₃. Al₂O₃ is in particular preferred, as it has a high melting point. The ceramic bodies may also compose certain ceramic bodies comprising or being composed of Cr₂O₃ and other ceramic bodies comprising or being composed of Al₂O₃. The aforementioned elements guarantee a good extraction and gravity flow behaviour of the molten ash being heated above the ash flow temperature.

In certain embodiments being combinable with all other embodiments herein, a ratio between a height of the ceramic bed and an average diameter of the ceramic bodies ranges from about 2 to about 40. Preferably, the ratio ranges from about 10 to about 30. In another preferred embodiment, the ratio may be between 8 and 12. This is further advantageous for providing an improved extraction and downflow behaviour of the molten ash.

In certain embodiments, the ceramic bodies have a diameter ranging from about 5 mm to about 50 mm Preferably, the diameter may range from about 7 mm to about 13 mm and more preferably be about 10 mm. In another preferred case, the diameter may range from about 20 mm to about 40 mm and more preferably be about 30 mm. Especially, the diameter may be ranging from about 5 mm to about 15 mm. These diameter ranges may be helpful for improving the extraction and flow of the molten ash to the outlet of the bottom part of the bulk layer separator.

In certain embodiments, combinable with all other embodiments herein, the ceramic bodies may comprise or be composed of Cr₂O₃ and have a diameter ranging from about 27 mm to about 33 mm, more preferably of about 30 mm.

In certain embodiments, combinable with all other embodiments herein, the ceramic bodies may comprise or be composed of Al₂O₃ and have a diameter ranging from about 7 mm to about 13 mm, more preferably of about 10 mm.

In particular, the ceramic bodies have a uniform shape. This guarantees a controlled extraction and gravity-induced down flow of the molten ash. A uniform shape can e.g. encompass a spherical shape having an even (uniform) geometry. A spherical shape can encompass a ball shape. Furthermore, the bodies may have other ceramic packing shapes.

In certain embodiments being combinable with all other embodiments herein, the plant does not involve a hot gas filter arranged downstream of the bulk layer separator.

In certain embodiments being combinable with all other embodiments herein, a liquid mineral film is conducted and granulated in a granulating bath below the bulk layer separator. In particular, the carbon-free granules can be landfilled or used as a product.

In certain embodiments, by-products such as methane, benzene, naphthalene, ammonia and the like can also be converted into raw gas within the bulk layer separator. In the case of ammonia conversion product may be nitrogen and hydrogen gas.

The bulk layer separator may include a supply for an oxidizing agent, the supply being arranged to deliver an oxidizing agent to the carbon-containing dust. In particular, the ceramic bed is arranged downstream of the supply. In particular, there can be one supply nozzle or a plurality of supply nozzles (and/or plasma torches) in the top part of the bulk layer separator.

In certain embodiments being combinable with all other embodiments herein, the bulk layer separator is configured to oxidize the carbon-content in the carbonaceous dust by applying a temperature being above the flow temperature of the ash.

In certain embodiments, being combinable with all other embodiments herein, the bulk layer separator is arranged that the carbonaceous dust is oxidized by means of oxygen, air and/or a thermal plasma. In case a thermal plasma is used, a thermal plasma as e.g. disclosed within US 2015/0252274 A1, which is incorporated herein in its entirety, may be used. In other words the carbon-containing dust and bottom ash product, together with by-products such as methane, higher molecular weight hydrocarbons, benzene, naphthalene, and ammonia are fully thermochemically decomposed and reformed into H₂ and CO by means of oxygen, air, or thermal plasma. Oxygen, air or thermal plasma may also be used as gasification agent as described herein.

In certain embodiments being combined with all other embodiments disclosed herein, the gasification reactor is a pressure-loaded gasification reactor and configured to be operated at a pressure ranging from about 200 kPa and about 3000 kPa. Optionally, the pressure ranges from about 1000 kPa to about 1500 kPa.

In certain embodiments being combinable with all other embodiments disclosed herein, a means, arranged downstream of a ceramic bed, being configured to oxidize a carbon-containing bottom ash, wherein said means is configured to generate a temperature for oxidation above the flow temperature of the ash is provided. The means for oxidizing can be a plasma torch or a supply for gasification agents such as air or oxygen. By supplying a gasification agent, the oxidation of carbon contained in bottom ash, i.e. ash which has passed the ceramic bad and involves remaining carbon, can take place. Optionally, the means is a thermal plasma torch.

Advantageously the conversion rate of raw gas is increased by the conversion of the carbonaceous dust and the by-products. The raw gas may be used in downstream plants for synthesis gas generation.

Device for the Thermal Conversion of Carbonaceous Dust from Raw Gases

In a second aspect, the present invention is directed to a device for the thermal conversion of carbonaceous dust from raw gases, comprising melting the mineral content of the dust in the liquid state and separating it from the raw gas within a ceramic bed.

As stated above, the device according to the second aspect of the present invention may be included in the plant according to the first aspect of the present invention. Alternatively the device according to the second aspect may also be a standalone device independently of the plant.

In view of the above aspects and embodiments, the term “device” may be used interchangeably with the term “bulk layer separator”. Therefore, all features relating to the bulk layer separator described in the section “plant” may also apply for the device. Therefore, the features and technical advantages will not be repeated for the sake of conciseness.

An electrodeless plasma torch being configured to generate a plasma may be arranged in the top part of the device. An advantage of an electrodeless plasma torch is that it can also be operated in pressure loaded devices.

Alternatively, a plasma torch such as disclosed in DE 10 2016 214 242 A1, which is incorporated herein by reference, may be arranged in the top part of the device. In particular, the plasma torch is arranged in a manner that a plasma flame is introduced into the device. In this particular case, an electrode for generating the plasma is not within the device but in a fluid channel, e.g. in the form of a ring electrode, in order to generate the plasma before the fluid enters the device in the form of a plasma flame. A plasma torch as described herein may comprise a fluid channel configured to transport a fluid stream. The fluid may be selected from the group consisting of steam, air, oxygen, nitrogen and carbon dioxide. In particular, more than one plasma torches might be used, such as two or three.

The device may also be operated in the pressure ranges disclosed for the gasification reactor herein.

Process for Converting Carbon-Containing Residues and Waste Materials into Synthesis Gas

In a third aspect, the present invention is directed to a process of converting carbon-containing residues and/or waste materials into synthesis gas or of thermally converting carbonaceous dust from raw gases, the process comprising the steps of:
heating the carbon containing residue, waste material or carbonaceous dust above a flow temperature of an ash included in the carbon containing residue, waste material or carbonaceous dust to obtain reformed clean synthesis gas and an ash melt; and
separating the ash melt within a ceramic bed.

The process according to the third aspect of the present invention may be applicable to the plant according to the first aspect of the present application and/or to the device according to the second aspect of the present invention. Accordingly, in order to avoid repetitions, it is stated that all features and technical advantages relating to the plant according to the first aspect of the present invention and/or the device according to the second aspect of the present invention equally apply to the process according to the third aspects of the present invention and vice versa.

In certain embodiments being combinable with all other embodiments herein, the process further comprises the step of:
leading the ash meld over the ceramic bed into a granulation bath using gravity force.

In certain embodiments being combinable with all other embodiments herein, the flow velocity of the synthesis gas ranges from about 1 m/s to about 15 m/s. Optionally, the flow velocity may range from about 8 m/s to about 12 m/s, more preferably the flow velocity is about 10 m/s. In another preferred embodiment, the flow velocity ranges from about 3 m/s to about 7 m/s, more preferably about 4 m/s to about 5 m/s.

The heating involves generating a temperature above the flow temperature of the ash. This temperature may be referred to the “average temperature”. This temperature may be controlled by means of nozzles inserting an oxidizing agent such as oxygen or plasma torches at the top part of the bulk layer separator. In certain embodiments being combinable with all other embodiments herein, the step of heating encompasses generating an average temperature of more than the ash flow temperature. Optionally, the heating involves generating an average temperature ranging from about 1200° C. to about 1800° C. within the bulk layer separator. In particular, different feedstocks with different ash characteristics may have different ash flow temperatures. The average temperature is uncritical, as long as it is above the ash flow temperature of the mineral components of the feedstock.

In certain embodiments being combinable with all other embodiments herein, the process further comprises subjecting the reformed clean synthesis gas to the steps of:
quenching;
saturating;
and/or scrubbing,
   wherein optionally the temperature of the synthesis gas after the scrubbing step is less than 300° C.

In certain embodiments being combinable with all other embodiments herein, the process does not encompass filtering the synthesis gas over a hot gas filter.

In certain embodiments being combinable with all other embodiments herein, the process further comprises a step of gasifying a carbon-containing feedstock in order to produce a carbon-containing residue and/or a carbon containing dust to be used in the step of heating. The step of gasifying may be carried out by a gasification reactor disclosed elsewhere herein.

In certain embodiments being combinable with all other embodiments herein, the process further comprises a step of oxidizing a carbon containing dust produced in the step of separating by heating the ash above its flow temperature.

In certain embodiments being combinable with all other documents herein, the process further comprises the step of leading the ash melt into a granulation bath after the step of separating. Preferably, this step is carried out after the step of oxidizing set forth above.

### DETAILED DESCRIPTION OF THE FIGURES

The Figures are merely for the purpose of illustration and not considered to be limiting.

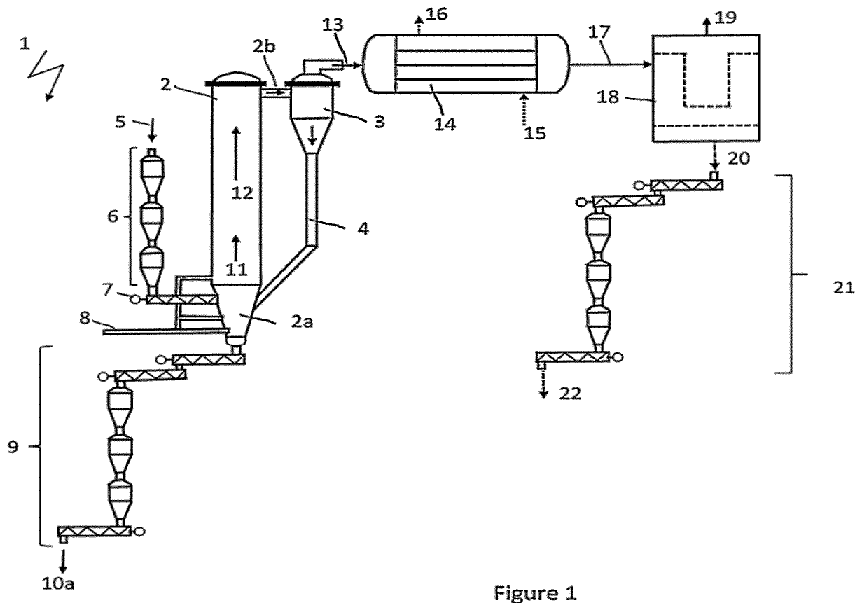

Referring to FIG. 1, there is shown a prior art gasification apparatus, generally designated (1), such as a high temperature Winkler gasifier. This is formed by a gasifier body (2) made of refractory masonry, which is provided with a conical outlet area (2a) at the bottom in the direction of gravity. A gas feed line (2b) to a cyclone (3) is positioned in the head area, with the cyclone (3) guiding the separated solid particles via a return line (4) into the lower area (2a) of the gasifier (2). The residual and waste materials (5) can be entered into the fluidized bed area (11) of the gasifier via a lock hopper and entry system (6 & 7). The feed lines for introducing gasification components (CO₂, steam, air/O₂) are denoted by (8) in FIG. 1. The bottom product (10a) can be transported for further processing via a discharge system (9).

Via the post-gasification zone (12) and after coarse separation in the cyclone (3), the raw gas produced can be cooled int raw gas cooler (14) from approx. 900° C. to approx. 300° C. The hot gas filter (18) is introduced via a pipeline (17). In the hot gas filter (18), the raw gas is freed from C-containing dust. The particle-free raw gas (19) can be used in further treatment measures to produce synthesis gas. The C-containing dust (20) can be returned to the fluidized bed area (2a) of the gasifier via a discharge system (21 & 22) or fed to separate incineration.

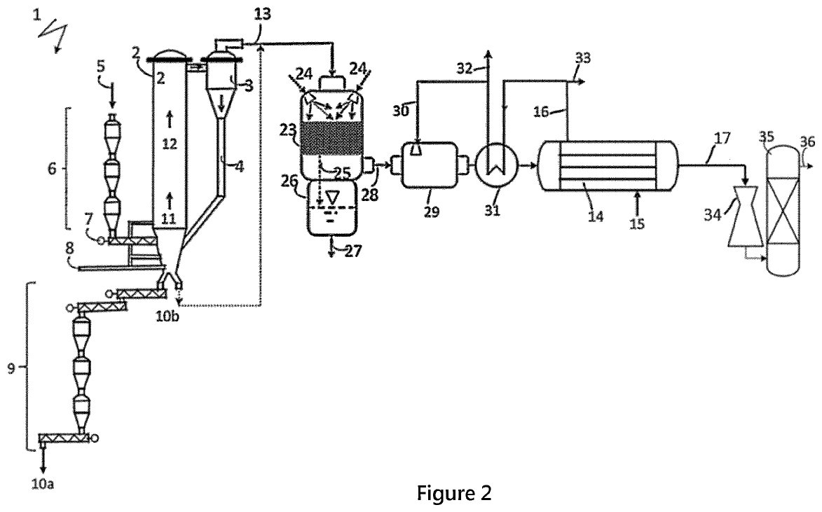

In FIG. 2 the device according to the invention is shown. First, the gasification takes place exactly as shown in FIG. 1. But downstream the gasifier (2) and recirculation cyclone (3,4) the device “Packed Bed Filter” (23) according to the invention is installed. The raw gas loaded with C-containing dust and gas by-products flows in the Packed Bed Filter (23) and subjected to oxygen in a reaction chamber located in front of Packed Bed Filter. The aim of this procedure is to convert (gasify) the remaining C content in the dust into useful gas and then to heat the mineral components of the dust that are then exposed to above the ash floating point.

Due to the increased temperature, these melt and are extracted as droplets forming a liquid mineral film on the ceramic bodies of the Packed Bed Filter, agglomerate and flow out of the ceramic bed with the help of gravity. With this measure, the raw gas can be separated from the particles in the packed bed filter. The separated liquid ash particles arrive as droplets in a granulating bath filled with water. A non-elutable granulate is formed as a result of the sudden cooling and solidification of the droplets. In addition, the bottom product can also be introduced into this device via line (10b) and subjected to the same procedure. Another task fulfilled by the plant and device according to the present invention is the conversion of gas by-products into valuable gas.

At the outlet of the packed bed filter the clean crude gas stream can be treated with superheated steam in a quench apparatus (29). This is followed by raw gas cooler (14) and then the raw gas is transferred to downstream devices for conversion to synthesis gas. A cost-intensive hot gas filter with extensive peripherals can be eliminated by means of this device according to the invention.

Overall, the device according to the invention using a Packed Bed Filter results in extensive economic advantages compared to the device in FIG. 1 according to the state of the art “hot gas filter with ceramic candles”, because the Packed Bed Filter, that can be used in the liquid aggregate state of the particles is highly efficient and very compact, preferably at high speeds of up to up to 15 m/s, hot gas filters, on the other hand, can only be used at flow velocities of a few cm/s, because otherwise the pressure loss would assume such high values that would prevent economical and trouble-free operation. In addition, the packed bed filter according to the invention does not require a cleaning device because the separated liquid ash can run off independently from the gussets of the ceramic bed into the granulating bath by gravity. For the candle filter system, on the other hand, a cleaning and discharge mechanism and a return device to the gasifier must be provided. Furthermore, additional facilities for the separation and disposal of the unwanted by-products from the synthesis gas stream must be provided in the downstream process path, when using “State of the Art” technology. The table below shows a comparison of both systems (prior art left; present invention right) with evaluation.

State of the Art (STA)

| | 1 | 2 |
|---|---|---|
| | Fluidized Bed | Fluidized Bed |
| | Gasifier | Gasifier |
| | (STA) | (Invention UM) |
| Gasifier and return cyclone | STA | STA |
| Feeding system | STA | STA |
| | | (smaller than 1 because |
| | | no dust return from WGF) |
| Discharge system | STA | STA |
| | | (smaller than 1 because |
| | | no dust return from WGF) |
| Post-treatment of | necessary | necessary |
| bottom product | | (considerably |
| | | more compact |
| | | because no dust |
| | | from WGF) |
| Packed bed filter | not necessary | New Device (Invention) |
| with granulating bath | | |
| quench device | not necessary | necessary |
| Warmgasfilter (WGF) | necessary | not necessary |
| Online/Offline | necessary | not necessery |
| Cleaning (WGR) | | |
| discharge system | necessary | not necessery |
| Additional sito | necessary | not necessary |
| (concentration measure) | | |
| dust return system | necessary | not necessary |
| Raw gas cooler | necessary | necessary |
| After-treatment by-products | necessary | not necessary |
| (benzen, NH3, . . .) | | |
| Synthesis | 100 | 110 |
| gas yield | (Benchmark) | |

### LIST OF REFERENCES SIGNS

1 gasification plant
2 gasifier
2a cone
2b gas flow
3 cyclone
4 return line
5 residual and waste materials
6 lock system
7 entry system
8 entry gasification agent
9 discharge system
10a bottom product for external after-treatment
10b bottom product for internal after-treatment
11 fluidized bed area
12 post-gasification zone
13 Feed line towards raw gas cooler
14 raw gas cooler
15 coolant inlet
16 coolant outlet
17 Feed line towards hot gas filter
18 hot gas filter
19 Dedusted raw gas
20 C containing dust
21 discharge system
22 dust return line
23 packed bed separator
24 reaction space for O₂—loading
25 liquid ash
26 granulating bath
27 granules
28 feed line to the quench device
29 quench device
30 superheated steam
31 steam superheater
32 superheated steam (supply, gasification nozzles)
33 process steam
34 Venturi scrubber
35 Syngas scrubber
36 Clean and cooled syngas

1-35. (canceled)

36. A plant configured for converting a carbon-containing residue or a waste material into a synthesis gas, the plant comprising:
a gasification reactor with an outlet and a fluidized bed zone in which the residue or the waste material is gasified by a gasification means, with a carbon-containing dust at the outlet of the gasification reactor in a raw gas; and
a bulk layer separator arranged downstream of the gasification reactor, in which the carbon-containing dust is oxidized by supplying an oxidizing agent, characterized in that the bulk layer separator is configured for oxidizing the carbon-containing dust and is operated above a flow temperature of an ash included in the carbon-containing residue or the waste material.

37. The plant according to claim 36, wherein the bulk layer separator comprises a ceramic bed comprising a plurality of ceramic bodies.

38. The plant according to claim 37, wherein at least one of the ceramic bodies is spherical.

39. The plant according to claim 37, wherein at least one of the ceramic bodies comprises a material selected from a group consisting of: Al₂O₃, SiO₂, SiC, Si₃N₄, B₄C, BN, Zr₂O₃, Cr₂O₃, MoSi₂, HfO₂, or a combination thereof.

40. The plant according to claim 37, wherein at least one of the ceramic bodies has a uniform shape or another ceramic packing shape.

41. The plant according to claim 37, wherein at least one of the ceramic bodies has a diameter ranging between about 5 mm and about 50 mm, inclusively.

42. The plant according to claim 37, wherein the ceramic bed has a height, wherein the ceramic bodies have an average diameter, wherein a ratio between the height of the ceramic bed and the average diameter of the ceramic bodies ranges between about 2 and about 40, inclusively.

43. A method for a thermal conversion of a carbonaceous dust from a raw gas, the method comprising:
melting a mineral content of a dust in a liquid state and separating the mineral content from the raw gas within a ceramic bed.

44. The plant according to claim 36, characterized in that a liquid mineral film is conducted and granulated in a granulating bath below the bulk layer separator at least when positioned upright.

45. The plant according to claim 36, characterized in that a by-product including an instance of methane, benzene, naphthalene, or ammonia can be converted into the raw gas within the bulk layer separator.

46. The plant according to claim 36, further comprising:
an oxidizing means, arranged downstream of the ceramic bed, the oxidizing means being configured to oxidize a carbon-containing bottom ash, wherein the oxidizing means is configured to generate a temperature for oxidation above the flow temperature of the ash, wherein the bulk layer separator has an inner volume, wherein the oxidizing means includes a thermal plasma torch, wherein the bulk layer separator is arranged such that a carbonaceous dust is oxidized by an instance of oxygen, air, or thermal plasma generated by an electrodeless plasma torch being configured to generate a flame which is introduced into the inner volume of the bulk layer separator.

47. The plant according to claim 36, characterized in that the raw gas is used in a downstream plant in a synthesis gas application.

48. The plant according to claim 36, wherein the bulk layer separator includes a supply for an oxidizing agent, wherein the supply is arranged to deliver an oxidizing agent to the carbon-containing, wherein the ceramic bed is arranged downstream of the supply.

49. A process of converting a carbon-containing residue or a waste material into a synthesis gas or of thermally converting a carbonaceous dust from a raw gas, the process comprising:
heating a carbon containing residue, a waste material or a carbonaceous dust above a flow temperature of an ash included in the carbon containing residue, the waste material or the carbonaceous dust to obtain a reformed clean synthesis gas and an ash melt; and
separating the ash melt within a ceramic bed.

50. The process according to claim 49, further comprising:
leading the ash melt over the ceramic bed into a granulation bath using a gravity force.

51. The process according to claim 49, wherein the synthesis gas has a flow velocity ranges between about 1 m/s and about 15 m/s, inclusively.

52. The process according to claim 49, wherein heating the carbon containing residue, the waste material or the carbonaceous dust above the flow temperature of the ash encompasses generating an average temperature ranging between about 1200° C. and about 1800° C., inclusively.

53. The process according to claim 49, further comprising:
subjecting the reformed clean synthesis gas to:
quenching,
saturating, or
scrubbing,
wherein the synthesis gas has a temperature after scrubbing at about 300° C. or less.

54. The process according to claim 49, further comprising:
gasifying a carbon-containing feedstock in order to produce a carbon-containing residue or a carbon containing dust to be used in heating the carbon containing residue, the waste material or the carbonaceous dust.

55. The process according to claim 49, further comprising:
oxidizing a carbon containing dust produced in separating the ash melt within the ceramic bed by heating the ash above the flow temperature.
